(19) United States
(12) Patent Application Publication
(10) Pub. No.: US 2005/0086213 A1
(43) Pub. Date: Apr. 21, 2005

(54) Server apparatus, information providing method and program product therefor

(75) Inventor: Taro Terao, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 10/959,053

(22) Filed: Oct. 7, 2004

(30) Foreign Application Priority Data
Oct. 16, 2003 (JP) P2003-357084

(51) Int. Cl. G06F 7/00

(52) U.S. Cl. 707/3

(57) ABSTRACT

A server apparatus is connected to a client apparatus and a database that stores an information element network including an information element as node. The server apparatus includes: a receiving unit that receives from the client apparatus a request to access a specific information element included in the information element network; an obtaining unit that obtains from the client apparatus information concerning an access history for the information element; and a determining unit that determines whether the client apparatus previously accessed an information element included in the information element network and is included in upper nodes with respect to the specific information element, and employs the determined result to ascertain whether to permit or deny access to the specific information element requested by the client apparatus.

### BACKGROUND OF THE INVENTION

1. Field of the Invention

The present invention relates to a server apparatus for providing information elements, such as documents, for a client. The present invention also relates to an information providing method and a program product therefor.

2. Description of the Related Art

As computer networks have developed, a variety of data have been provided by the computer networks. An example in which data held by a conventional web server apparatus are accessed across a network will now be described while referring to FIG. 12.

FIG. 12 is a block diagram showing the configuration of an example computer network system. As is shown in FIG. 12, a conventional computer network system includes a web server apparatus 1, a client apparatus 2 and a network 3 for interconnecting them. The network 3 may be the Ethernet (registered trademark). As the simplest example, a hub is provided for the network to form an electrical communication path by connecting a network interface card at the web server apparatus 1 to the hub, and the network interface card of a client apparatus 2 to the hub using twisted pair cables.

It has been given for the presence of a technique whereby the web server apparatus 1 and the client apparatus 2 exchange information consisting of a character string by using an electric signal, and whereby based on this information, an instruction (method) or the designation of a resource, such as a document or a program, to be instructed, are issued to the web server apparatus 1 to permit the web server apparatus to perform a process for providing or executing the designated resource, and for the presence of a technique whereby, based on a character string received by the client apparatus 2, the client apparatus 2 displays the character string, or performs a process in accordance with a program description included in the character string.

An explanation will now be given for an example conventional process for providing data for only a specific user by employing these techniques.

In this example, it is assumed that at least one document (referred to a target resource in this example), containing information that is to be provided is stored on a magnetic disk in the web server apparatus 1. Further, in this example, a process is performed for inhibiting the provision of the document to users other than the user of the client apparatus 2.

The name (user name) of the user of the client apparatus 2 and a password character string selected by the user are stored on the magnetic disk of the web server apparatus 1, in correlation with each other. This correlation can be prepared by using, for example, a database. To prepare a database, several well known methods are used, including a method that employs a basic data structure, such as a binary tree (B—Tree), as a basic data structure for recording a user name and a password in correlation with each other.

The concept of a database for recording user names and passwords in correlation with each other can be expressed as is shown in FIG. 13, by using a table.

However, according to the data provision system described in the conventional example, since a user must be registered in advance, or since information used as an access key must be provided for the user, a database for managing information for each user is inevitably required for access control, and usability is low, e.g., the system requires a considerable amount of work for maintaining the database.

Furthermore, the policy setup for system operations, such as user registration and distribution of an access key, is concentrated onto service administrator, and it is difficult to decentralize the work for the user registration and the distribution of the access key. As a result, a complicated policy cannot be easily applied as a whole.

### SUMMARY OF THE INVENTION

The present invention has been made in view of the above circumstances and provides a server apparatus that can exercise access control without managing information for each user, and that can decentralize the policy setup process, so that the usability can be improved, and an information providing method and program therefor.

According to an aspect of the invention, there is provided a server apparatus connected to a client apparatus and a database that stores an information element network including information elements as nodes, the server apparatus including: a receiving unit that receives from the client apparatus a request to access a specific information element included in the information element network; an obtaining unit that obtains from the client apparatus information concerning an access history for the information elements; and a determining unit that determines whether the client apparatus previously accessed an information element included in the information element network and is included in upper nodes with respect to the specific information element, and employs the determined result to ascertain whether to permit or deny access to the specific information element requested by the client apparatus.

### BRIEF DESCRIPTION OF THE DRAWINGS

Embodiments of the present invention will be described in detail based on the following figures, wherein:

FIG. 1 is a block diagram showing a connection between a web server apparatus according to an embodiment of the present invention and a network;

FIGS. 2A and 2B are diagrams for explaining an example information element network in an acyclic digraph shape;

FIG. 3 is a diagram for explaining an example wherein the information element network in the acyclic digraph shape is provided by using HTML description;

FIG. 4 is a diagram for explaining an example table that is referred to when the permission of an access to an information element is determined;

FIG. 5 is a diagram for explaining another table that is referred to when the permission of access to an information element is determined;

FIG. 6 is a flowchart showing an example browsing process performed by the web server apparatus according to the embodiment of the present invention;

FIG. 7 is a flowchart showing an example editing process performed by the web server apparatus according to the embodiment of the present invention;

FIG. 8 is a flowchart showing an example commitment process performed by the web server apparatus according to the embodiment of the present invention;

FIG. 9 is a flowchart showing an example generation process performed by the web server apparatus according to the embodiment of the present invention;

FIG. 10 is a flowchart showing an example “inform” process performed by the web server apparatus according to the embodiment of the present invention;

FIG. 11 is a diagram for explaining an additional table that is referred to when the permission of the access to an information element is determined;

FIG. 12 is a diagram showing an example conventional, general network system including a web server apparatus; and

FIG. 13 is a diagram for explaining an example table for conventional, generate access management.

### DETAILED DESCRIPTION OF THE EMBODIMENT

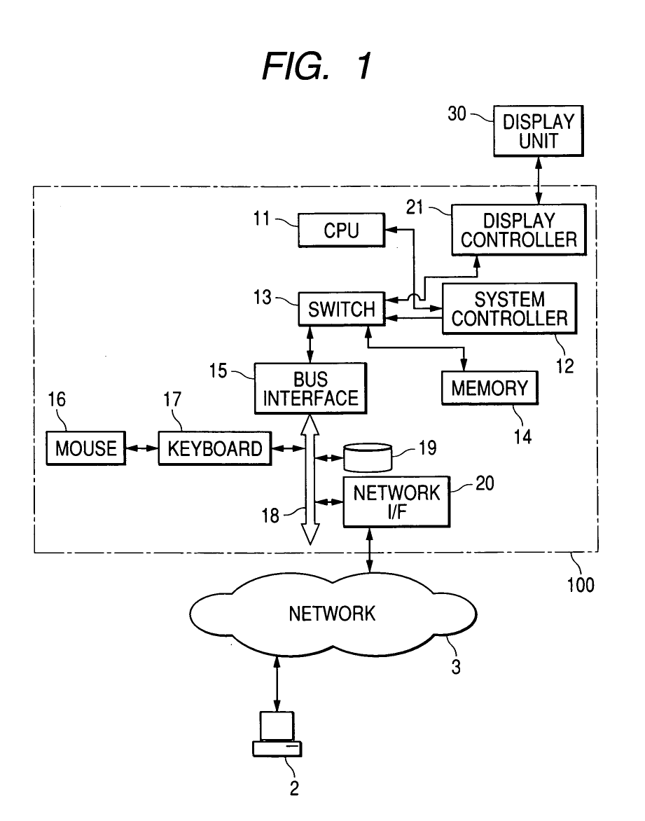

In a first embodiment, as is shown in FIG. 1, a web server apparatus 100 according to the embodiment includes: a CPU 11, a system controller 12, a switch 13, a memory 14, a bus interface 15, a mouse 16, a keyboard 17, a bus 18, a magnetic disk 19, a network interface (I/F) 20 and a display controller 21, which is connected to a display unit 30. The network I/F 20 of the web server apparatus 100 is connected to a client apparatus 2 through a network 3.

The CPU 11 reads a program from the magnetic disk 19, and performs the processing as a web server apparatus in accordance with the program. The processing for the web server apparatus, performed by the CPU 11 will be described later in detail.

In accordance with an instruction transmitted from the CPU 11, the system controller 12 outputs a signal to the switch 13 to designate a destination that exchanges data with the CPU 11. In accordance with the signal received from the system controller 12, the switch 13 connects, to one of the components, such as the memory 14, the bus interface 15 and the display controller 21, a signal line for exchanging data with the CPU 11.

The memory 14 is basically a RAM (Random Access Memory), and when a writing instruction and data to be written are received from the CPU 11, the data are stored in the memory 14. In this case, the writing instruction includes address information representing the data write position in the memory 14. Further, upon receiving a reading instruction from the CPU 11, data indicated by address information included in the reading instruction is read from the memory 14, and output to the CPU 11.

The bus interface 15 controls the bus 18, and a signal is exchanged through the bus 18, between the individual sections, such as the keyboard 17, the magnetic disk 19 and the network I/F 20. When the signal is received from the CPU 11, the bus interface 15 transmits this signal through the bus 18. Further, when signals are received from the keyboard 17, the magnetic disk 19 and the network I/F 20, the bus interface 15 transmits these signals to the CPU 11.

The mouse 16 is connected to the bus 18 through the keyboard 17. The mouse 16 is so-called a pointing device, and when a user moves the main body of the mouse 16 across a desk, information corresponding to the traveling distance of the mouse 16 is output to the bus 18 through the keyboard 17. In the embodiment, the mouse 16 is connected to the bus 18 through the keyboard-17; however, a mouse may be connected directly to a bus.

The keyboard 17 is a device used to enter character strings, and information representing the character string entered by a user is output to the bus 18.

The magnetic disk 19 is, for example, a hard disk, and a writing instruction and data to be written that are received through the bus 18 from the CPU 11 are converted into magnetic signals, which are recorded on the magnetic disk face. Further, when a reading instruction is received from the CPU 11 through the bus 18, corresponding information is read from the face of the magnetic disk 19 by a magnetic head, and is converted into en electric signal, and the electric signal is output to the bus 18.

The network I/F 20 receives, from the CPU 11, target transmission data including address information for a transmission destination, converts the target transmission data into an electric signal appropriate for the network 3, and transmits the electric signal to the network 3. Furthermore, the network I/F 20 demodulates an electric signal received through the network 3 to obtain data, and determines whether the obtained data is for a destination corresponding to an address that is pre-allocated to the network I/F 20. When the data is not for the destination, the data is abandoned. When the data is for the destination corresponding to the address that is pre-allocated to the network I/F 20, the data is output to the bus 18.

That is, the web server apparatus 100 in the embodiment performs the following operation when the CPU 11 writes information to or reads information from the magnetic disk 19. First, the CPU 11 instructs the system controller 12 to connect the switch 13 to the bus interface 15. Then, the system controller 12 instructs the switch 13 to connect the signal line of the CPU 11 to the bus interface 15, and the switch 13 connects the signal line from the CPU 11 to the bus interface 15.

In this state, when the CPU 11 outputs, through the signal line to the bus interface 15, a signal writing instruction and target data to be written to the magnetic disk 19, the data is recorded on the magnetic disk 19. When the CPU 11 outputs, to the bus interface 15, a signal reading instruction for reading data from the magnetic disk 19, the data is read from the magnetic disk 19, and is output through the bus interface 15 to the CPU 11. Hereinafter, this operation is briefly written as “the CPU 11 writes data to the magnetic disk 19” or “the CPU 11 reads data from the magnetic disk 19”.

In the same manner, the operation is performed for the network I/F 20, and hereinafter this operation is briefly written as “the CPU 11 transmits data through the network 3” or “the CPU 11 receives data through the network 3”.

Resources are stored on the magnetic disk 19, and a database for holding information elements (resources) such as documents is constructed in the magnetic disk 19. For simplification of the following explanation, a document is employed as an information element.

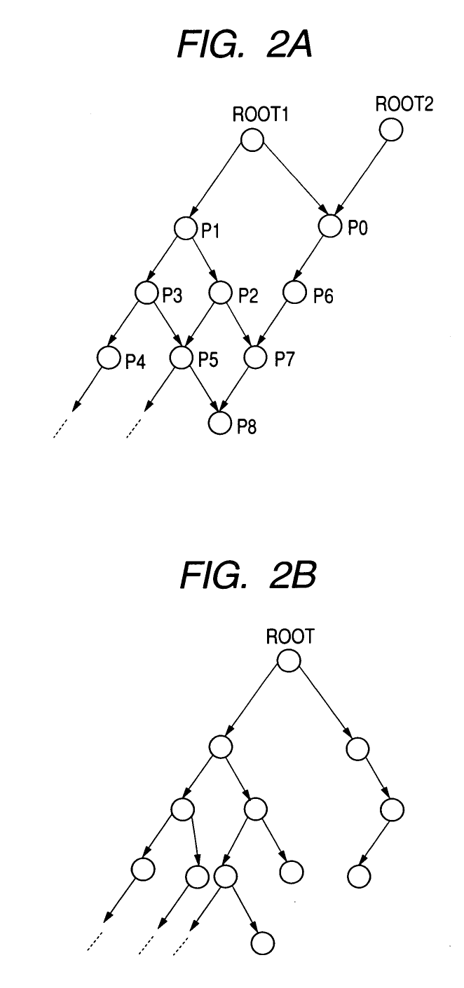

As one of the characteristics of the embodiment, a reference is defined between the information elements, and is used as an information element network in the shape of an acyclic digraph wherein the information elements are used as nodes. The acyclic digraph is as is shown in FIG. 2A, and in FIGS. 2A and 2B, the individual nodes are denoted by circles, and the reference is shown by using arrows. For example, destinations referred to by a “root” node are nodes P0 and P1, while a source node referred to by the node P0 is the root node. As is described above, the reference has directivity, and the reference can be tracked from the root node to the node P0 that is a reference destination, while the reference cannot be tracked from the node P0 to the node root that is the reference source. Since the concept of the acyclic digraph includes a directed tree shown in FIG. 2B, the state for the storage of the information elements in the embodiment also includes an information element network of a directed tree shape.

The entire information element network may include a plurality of roots, like the information element network shown in FIG. 2A that includes two roots or smaller. Furthermore, as is shown in FIG. 2A, the same node (node P0 in FIG. 2A) may be linked as a lower node to these multiple roots.

In the following explanation, several nodes are employed as target nodes, and other nodes (not target nodes) that can be reached by tracking the reference from the target nodes are called “lower nodes” of the target nodes, and nodes (not target nodes) that can reach the target nodes by tracking the reference are called “upper nodes” of the target nodes. In the examples shown in FIGS. 2A and 2B, when node P2 is a target node, nodes P5, P7, P8, . . . are lower nodes of the node P2, while node P1 and a root are upper nodes of the node P2.

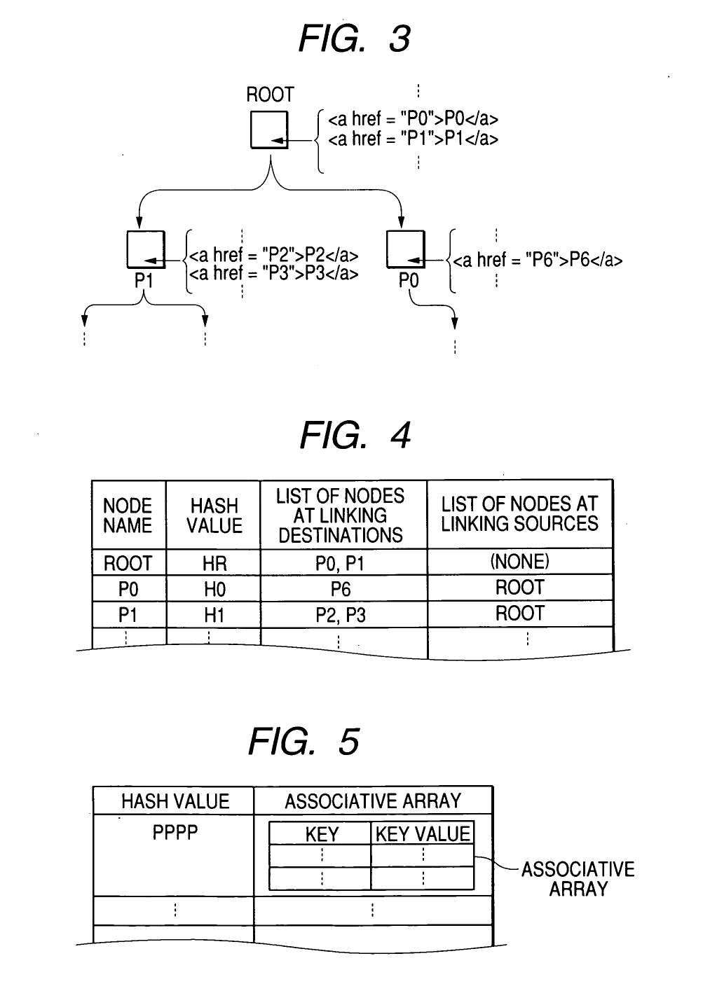

When a specific document is written in HTML, the reference can be described using an “A tag”. For example, the reference to the node P0 can be written as “<a href=“P0”>P0</a>” (see FIG. 3).

As is shown in FIG. 4, the name (node name) of each document that is a node, a hash value that represents a characteristic parameter obtained based on the contents of the document, a list of nodes that are reference destinations (HTML linking destinations) for the document, and a list of nodes that are reference sources (HTML linking sources) for the document are stored on the magnetic disk 19, in correlation with each other. The table shown in FIG. 4 can be actually stored as a database by using a general method. In FIG. 4, when there is no linking destination or no linking source, “(none)” is entered to easily recognize.

The hash value is a value obtained by a predetermined one-way function based on a character string included in a document. Since the method for calculating the hash value is well known, no detailed explanation for this will be given. The hash value can be represented as a string of about 20 bytes; however, the length is not limited to this, and may be about 64 bytes. In accordance with the length of the hash value, in the space formed of all the available characteristic parameters, the probability of the distribution of one of the available characteristic parameters that corresponds to one of information elements can be set equal to or smaller than a predetermined value.

Operation of the CPU 11

The processing performed by the CPU 11 will now be described. In the embodiment, the CPU 11 functions as a conventional web server apparatus, and a program for providing information is stored as a resource (in the following explanation, “wiki.cgi” is regarded as the resource name of this resource) on the magnetic disk 19. When, together with the GET method, URL “http://server apparatus/wiki.cgi” is designated as one type of URI by the client apparatus 2, a program for providing this information is activated. In the embodiment, it is assumed that a DNS (domain name system) server apparatus connected to the network 3 stores name “server apparatus” in correlation with an IP address that is allocated to the network I/F 20 of the web server apparatus 100, and that the client apparatus 2 can exchange information with the web server apparatus 100 by using the name “server apparatus”.

Further, in the embodiment, a request name and a resource (a resource included in the information element network in the acyclic digraph shape) requested in consonance with the request name are designated as process parameters for the information provision program. The information provision program in the embodiment includes program modules to respond to a request for browsing (“view”) a designated resource, a request for editing a designated resource (“edit”; accompanying the generation of a new resource, if available, that is a reference destination from the designated resource), a request for generating (“create”) a new resource that is a reference source to the designated resource, and a request for permitting (“inform”) of a first access to the designated resource.

The client apparatus 2 employs the following form (called a request text) to transmit as a request name and a resource requested in consonance with the request name.
http://server apparatus/wiki.cgi/resource?edit

In this request text, “resource” corresponds to a designated resource, and a character string following “?” represents a process parameter (query), which is request name “edit” in this case. As for the browsing process that is a basic process, so long as http://server apparatus/wiki.cgi/resource is entered, it may be assumed that the browsing is designated, without “view” being entered as a query.

The CPU 11 receives the request text from the client apparatus 2 through the network 3, examines whether the process parameter is added to the request text. When the process parameter is not added to the request text, the CPU 11 regards the request as a browsing request, and initiates a process to respond to the browsing request. Also, in case that the process parameter is added, when the process parameter “view” is added to the request text, the CPU 11 assumes that a request is for browsing, and initiates a process to respond to this request. When the process parameter is “edit”, the CPU 11 assumes a request is for editing, and begins a process to respond to the request. When the process parameter is “create”, the CPU 11 assumes a request is for creating, and begins a process to respond to this request. When the process parameter is “inform”, the CPU 11 assumes a request is for “inform”, the CPU 11 initiates a process to respond to this request. The processes to respond to these requests will now be described.

Process Performed for Request Name “View”

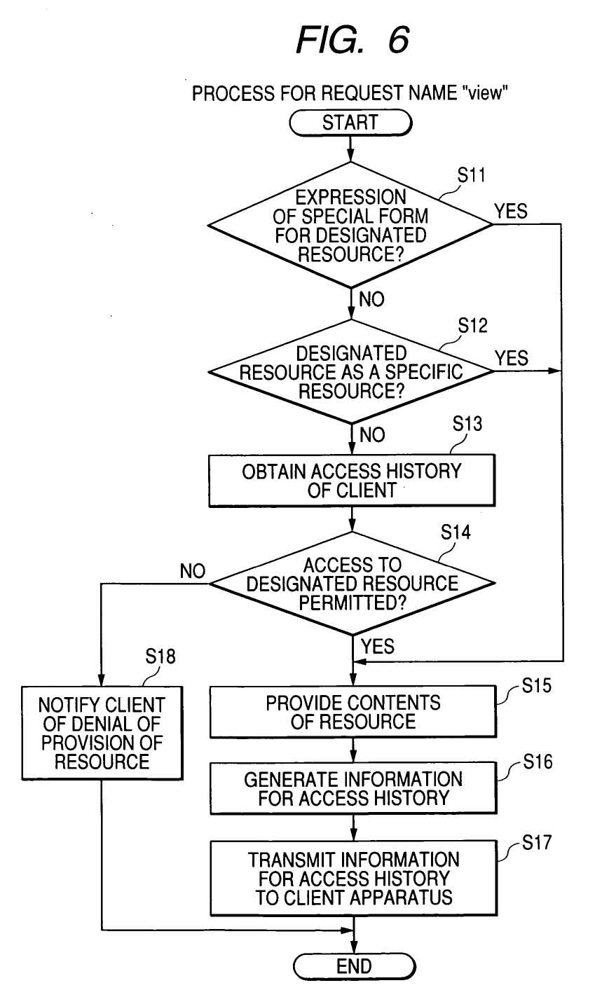

First, the process performed for request name “view” will be described while referring to FIG. 6. The CPU 11 determines whether the expression of a designated resource matches a predesignated condition (hereinafter referred to as expression of a special form) (S11). When the expression is not for special form (decision “N”), the CPU 11 determines whether the designated resource is a predesignated open resource (S12).

The open resource is a resource, such as “index.html” or “search.html”, disclosed in public, i.e., a resource accessible by any user. Since the list for the open resources is prepared in advance, and is stored in the memory 14, the CPU 11 determines whether the designated resource is included on the list.

The open resources may include a resource, such as “index.html”, that provides a list of resources that the user had referred to, and a resource, such as “search.html”, that provides a data search interface in resources that the user had referred to. Resources (lower nodes) at linking destinations from the open resources are also regarded as open resources.

When at step S12 the designated resource is not an open resource, the CPU 11 obtains, from the client apparatus 2, an access history held by the client apparatus 2 (S13). The access history held by the client apparatus 2 can be stored as a cookie, and the cookie is included in the Cookie field of an HTTP request to be provided for the server apparatus 100. It is preferable that a “secure” attribute be added to the cookie, and an encrypted HTTP request be transmitted.

The access history may be the list of resource names, or information for specifying a list of resources that the user accessed in the past. This is also an example client context according to the invention. While a node name corresponding to a resource that the user had accessed is employed as key, an associative array, which includes an entry wherein the “key value” is a hash value obtained based on the contents of the resource, is stored in correlation with the hash value of the associative array, as is shown in FIG. 5.

The CPU 11 employs the obtained access history to determine whether the access to the designated resource should be permitted (S14). This determination is performed as follows. The CPU 11 employs the access history to specify a list for resources that the user had accessed, and determines whether the designated resource is included on the list, or whether the designated resource can be reached by tracking the reference from a resource on the list, i.e., whether the designated resource is included at least as one of lower nodes for some resources included on the list.

When the designated resource corresponds to, for example, the node P5 in FIG. 2A or 2B, and when the user who requests the resource had accessed the resource corresponding to the node P1 (in this case, receiving of the contents of the resource in response to the “view” or “edit” request is called an access), it is assumed that the resource corresponding to the node P1 is included on the list of resources that is provided as the access history for the user.

Assume that the hash value corresponding to the node P0 is H0, the hash value corresponding to the node P1 is H1, . . . . Then, as is shown in FIG. 5, while node name “P1” is employed as a key and its hash value “H1” is employed as a “key value”, a hash value is designated in the access history for a user who had accessed the resource corresponding to the node P1 in order to determine an associative array that includes an entry that correlates the key with the key value.

Based on the hash value received as the access history from the client apparatus 2, the CPU 11 obtains an associative array from the table shown in FIG. 5. Then, the CPU 11 employs the associative array to obtain, as a list of keys for the associative array, the list of node names that the user of the client apparatus 2 had accessed. Following this, the CPU 11 examines the table shown in FIG. 4 by using, as a start point, a node that is represented by each node name included in the associative array, and selects nodes that can be recursively reached by using a list by which the lower nodes are referred to. Thereafter, the CPU 11 examines whether there is a node that matches the node corresponding to the designated resource, or whether, as a result of tracking the reference until the leaf (end node), there are no nodes that match the node corresponding to the designated resource.

When, as a result of this search, the CPU 11 does not find any node that matches a node corresponding to the designated resource, the CPU 11 determines that the access to the designated resource should be denied. When, as a result of the search, the CPU 11 finds a node that matches the node corresponding to the designated resource, the CPU 11 determines that the access to the designated resource can be permitted.

Through this processing, when the CPU 11 determines that the access to the resource designated at step S14 should be permitted (decision “Y”), the CPU 11 reads, from the magnetic disk 19, the contents of a document that is the designated resource, and transmits, to the client apparatus 2 through the network 3, a response chain that includes the document contents as an entity body (S15). The entity body may be generated based on the contents of the document and the access history. For example, the entity body may include, as a feedback link, a link to one of the node names that is included on the list of linking source nodes correlated with the designated resource and that is included in the associative array obtained based on the access history.

The CPU 11 adds, to the associative array obtained based on the access history of the user, an entry that includes the node name, which represents the accessed resource, and the hash value, which is generated based on the contents of the accessed resource, and generates new information for the access history (S16). Further, the CPU 11 calculates a hash value based on the new associative array, and enters the hash value to the table shown in FIG. 5.

When, for example, the accessed resource corresponds to the node P5, the CPU 11 adds, to the associative array, an entry that includes the node P5 and the hash value H5, and generates a new associative array. Based on the new associative array, the CPU 11 calculates a hash value, and enters this hash value to the database of the magnetic disk 19 that provides the table in FIG. 5, in correlation with the newly generated associative array.

When the contents of a document are changed, the hash value corresponding to the node is sometimes changed. For example, when the hash value H2 is changed to H′2, the contents of the database providing the table in FIG. 4 should be updated, while the information included in the associative array need not always be changed. This is because the user can employ the information included in the associative array as information that represents the state when the user browsed the data in the past.

The CPU 11 transmits, to the client apparatus 2, the information of the access history generated at step S15, and the client apparatus 2 stores the information (S17). The process at step S17 can be performed by designating the process in Set-Cookie/Set-Cookie2 field of an HTTP response header. At this time, the cookie is encrypted by adding a “secure” attribute, and the encrypted cookie is transmitted. The CPU 11 updates the information of the access history for the client apparatus 2, and thereafter terminates the processing.

When the CPU 11 determines at step S14 that the access to the designated resource should be denied, the CPU 11 transmits, to the client apparatus 2, a notification indicating that provision of information is not permitted (S18). The processing is thereafter terminated. This notification can be issued by transmitting an error code as the status code of a response chain. Upon receiving the notification, the client apparatus 2 displays message “401 Unauthorized” on the screen of the web client. The error code may be 404 instead of 401, and instead of an error code, a vacant entity body may be transmitted.

When the expression of the designated resource is for a special form at step S11, or when the designated resource is a specified resource at step S12, program control is shifted to step S15 to perform the succeeding processes, and the contents of a document corresponding to the designated resource are provided. At this time, the CPU 11 transmits an HTTP response wherein information for a newly generated access history is designated as a cookie, the normal node name obtained by converting the special form is designated as a location field, and the entity body is vacant. Then, the CPU 11 permits the client apparatus 2 to access a resource designated in the location field. Process performed for request name “edit”

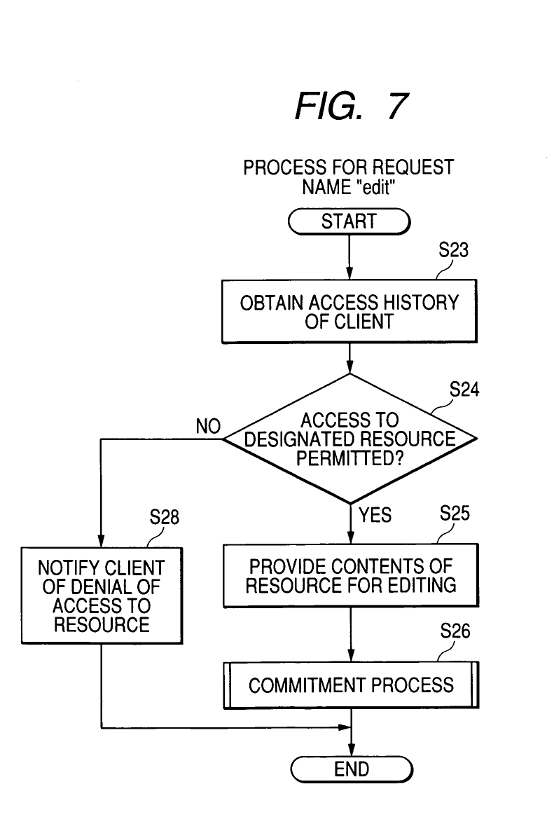

The process performed for request name “edit” will now be explained while referring to FIG. 7. First, the CPU 11 obtains an access history from the client apparatus 2 (S23), and employs the access history to determine whether the access to a designated resource should be permitted (S24).

Since the processes at steps S23 and S24 are the same as those at steps S11 to S14 in FIG. 6, no further explanation for them will be given.

When the CPU 11 determines at step S24 that the access to the designated resource should be permitted (decision “Y”), the CPU 11 reads, from the magnetic disk 19, the contents of a document that is the designated resource, and transmits, to the client apparatus 2 through the network 3, a response chain that includes the document contents as an entity body. Then, the client apparatus 2 edits the response chain (S25). That is, the response chain is transmitted in a form that can be edited. For example, by using the HTML, the contents of the document are added as the contents of a text area (<textarea>) in a form (in a form tag).

When the client apparatus 2 transmits (“submit”) a contents of the form, the CPU 11 receives an HTTP request that includes the contents of the form, the CPU 11 begins a commitment process (a process for establishing the contents to be edited) for the editing contents (S26). Through the commitment process, which will be described later, the contents to be edited are established.

When the CPU 11 determines at step S24 that the access to the designated resource is denied, the CPU 11 transmits, to the client apparatus 2, a notification indicating that the provision of the resource is not permitted (S28). The processing is thereafter terminated. This notification can be issued by, for example, transmitting an error code as the status code of a response chain. In this case, as well as in the previous example, the client apparatus 2 displays a message “401 Unauthorized” on the screen of the web client.

The commitment process will now be descried. When the CPU 11 receives an HTTP request including the contents of the edited form, the CPU 11 obtains the access history from the client apparatus 2, and employs the access history to determine whether the access to the designated resource should be permitted (the same processes at steps S23 and S24). When the access should not be permitted, the CPU 11 transmits, to the client apparatus 2, a notification indicating that the access to the resource is denied (the process at step S28). The processing is thereafter terminated.

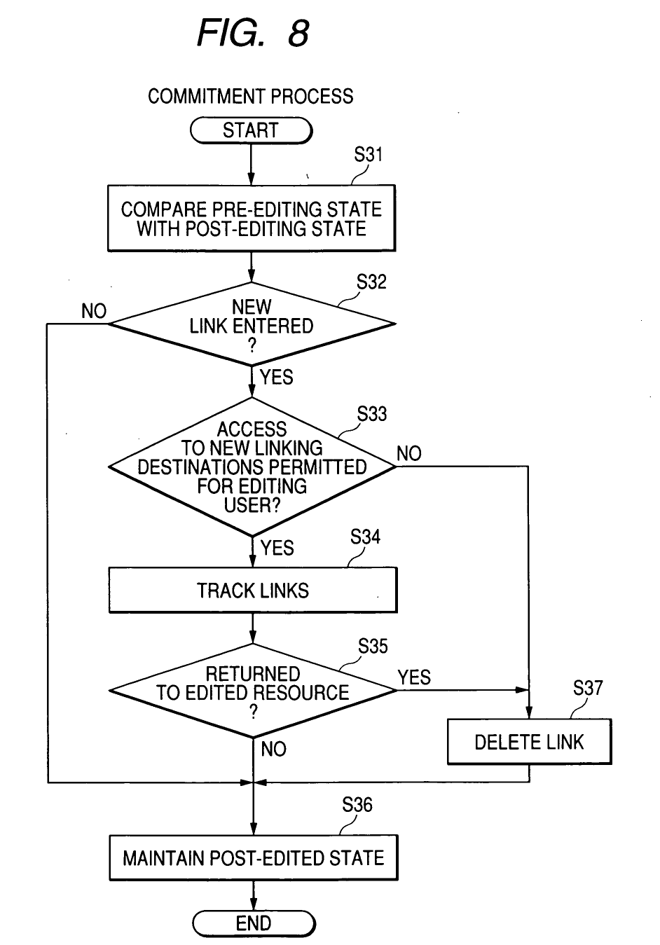

When the access should be permitted, the CPU 11 starts the process shown in FIG. 8. Specifically, the CPU 11 compares the contents of the resource before being edited with the contents after being edited (S31). This comparison process is a general process for extracting a difference in a document (command “diff” normally employed for UNIX (trademark), for example, can be employed to perform the process). The CPU 11 determines whether a new link is included as the results of editing (S32). In this process, a check is performed to determine whether an A tag is additionally written as the results of the “diff” process. When a new link is added (decision “Y”), the CPU 11 determines whether a user who edited the resource contents can access the new linking destination (reference destination) (S33).

The process for determining the permission of the access can be performed in the same manner as for the process at step S14 in FIG. 6. That is, a check need be performed to determine whether the user had accessed a resource higher than the resource that is designated as the new linking destination.

Next, the CPU 11 tracks the reference from the new linking destination in order to maintain the noncyclic property of the information element network (S34). Then, the CPU 11 determines whether the resource edited at step S25 can be reached, i.e., whether the reference is a cyclic reference (S35). When the reference is acyclic (decision “N”), the resource edited at step S25 in FIG. 7 is stored on the magnetic disk 19 (S36). Thereafter, the CPU 11 determines whether the resource is a newly generated one. When the resource is new, the CPU 11 retains the linking destination resource to the information element network in the magnetic disk 19.

When it is determined at S33 that the access to the new linking destination is denied (decision “N”), or when it is determined at step S35 that the reference is cyclic (decision “Y”), the CPU 11 deletes the description for the new link (S37), and thereafter terminates the processing. For deleting the new link, either only the A tag, or the entire description may be deleted. That is, when the user can not access link destination Pn that is <a href=“Pn”>Pn</a>, or when the linking destination Pn is located higher than the resource that is being edited, the CPU 11 may delete <a href=“Pn”> and </a>, and maintain only Pn, or may delete entire <a href=“Pn”>Pn</a>.

When the link is not added to the information element network at step S32 (decision “N”), the CPU 11 shifts the process to S36.

Process Performed for Request Name “Create”

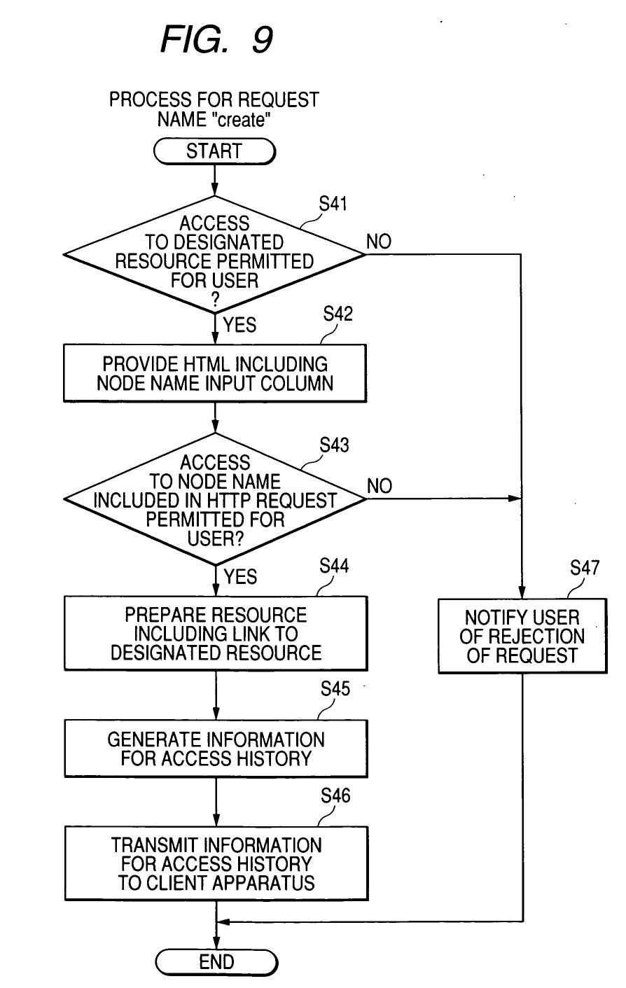

The process performed for request name “create” will now be described while referring to FIG. 9. First, the CPU 11 determines whether a user can access a designated resource (S41). This process can be performed in the same manner as at step S14 in FIG. 6. When the CPU 11 determines at step S41 that the access is permitted (decision “Y”), the CPU 11 transmits, to the client apparatus 2, an HTTP response that includes, as an entity body, HTML description including the form of an node name input column (S42). In this case, a name corresponding to the designated resource may be entered in advance in the node name input column. The input column should be editable, so that the user can enter an arbitrary node name.

When the client apparatus 2 transmits an HTTP request (commitment instruction relative to request name “create”) including the node name, the CPU 11 determines whether the user can access a node corresponding to the node name included in the HTTP request (S43). The process at step S43 is authentication for an access permission in the commitment process, and is the same as the process at step S41.

When the designated node name is already used and when the user does not have an access permission for a resource identified by the node name, the CPU 11 may permit the user to enter another resource name. Further, when the designated node name is already used, and when the user as an access permission for the resource identified by the node name, the CPU 11 permits the user to browse the resource identified by the node name.

When the CPU 11 determines that the user has an access permission, the CPU 11 prepares a resource including a link to the node corresponding to the designated node name (S44) and stores the resource in the information element network in the magnetic disk 19. That is, in this process, the CPU 11 generates a new resource that is located immediately above the designated resource.

Following this, the CPU 11 calculates a hash value corresponding to the node that is the generated resource, and adds the hash value to the database in FIG. 4. Further, the CPU 11 correlates the node name of the generated resource with the hash value obtained based on the contents of the resource, and adds an entry including these data to the access history for the client apparatus 2 that is obtained at step S41. In this manner, new information for the access history is generated (S45). The CPU 11 transmits, to the client apparatus 2, the new information for the access history generated at step S45, and the client apparatus 2 stores this information (S46). The process at S46 can be performed by designating the process in the Set-Cookie/Set-Cookie2 field of the HTTP response header. At this time, before transmission, the cookie is also encrypted by adding the “secure” attribute.

For the HTTP response, the location field is set to designate browsing of the new resource, and an entity body is vacant.

Through this processing, the CPU 11 updates the information for the access history for the client apparatus 2, and thereafter terminates the processing, or may redirect to browsing of the newly generated resource.

When the CPU 11 determines at steps S41 or S43 that the user should not be permitted to access the designated resource (decision “N”), the CPU 11 transmits to the client apparatus 2 information indicating the request is not accepted, so that the user is notified (S47). This notification can be issued by, for example, transmitting an error code as the status code of a response chain. Upon receiving this notification, the client apparatus 2 displays a message “401 Unauthorized” on the screen of the web client.

At step S43, the CPU 11 may transmit a form to re-enter a new node name.

Process Performed for Request Name “Inform”

As is described above for the embodiment, based on information for resources that the client apparatus 2 had accessed, the web server apparatus 100 determines whether the access to the requested resource should be permitted. In this process, the information element network in the acyclic digraph shape is prepared by using, as nodes, information elements that are resources, and is stored on the magnetic disk 19. When a resource is designated and an access to this resource is requested, a check is performed to determine whether the user had accessed any resources located above the designated resource in the information element network, so that the permission of the access to the designated resource is determined.

Therefore, for a user who accesses the web server apparatus 100 at the first time, since there are no resources that were accessed by the user, lower resources are not present, so that the situation wherein the user can not access any resources occurs (it should be noted that the user can access resources lower than open resources).

In order to enable accessing of a resource, an exception process must be provided in which, when one of the resources is accessed at the first time, the determination of the presence/absence of the access to higher resources is not performed.

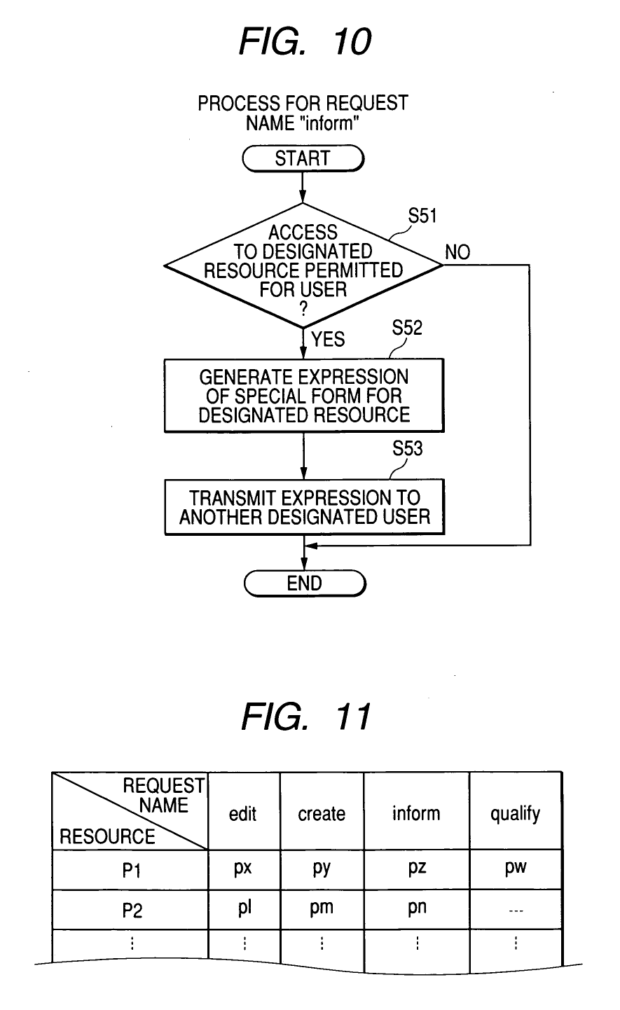

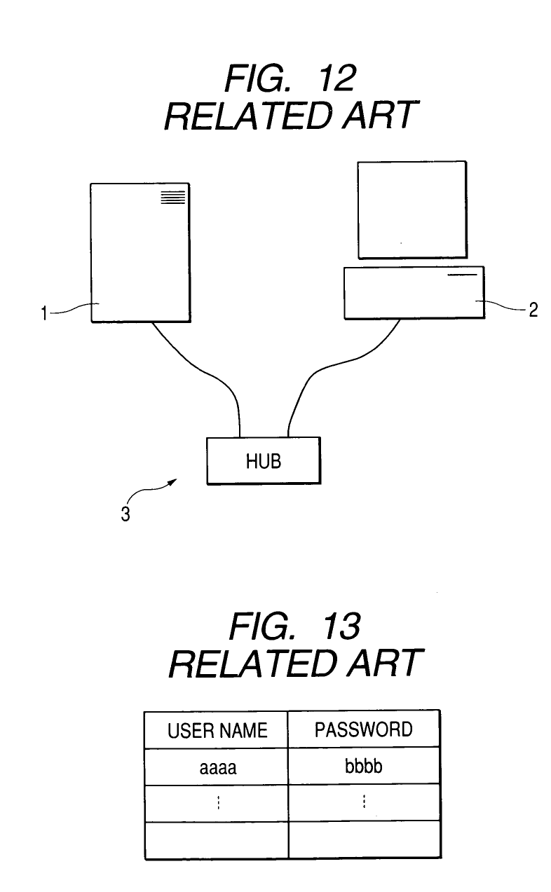

In the embodiment, therefore, the process for request name “inform” is prepared. The process performed for request name “inform” will now be described while referring to FIG. 10.

In this process, first, the CPU 11 determines whether a requesting user can access a designated resource (target resource for “inform”) (S51). This process can be performed in the same manner as at step S14 in FIG. 6.

When the CPU 11 determines at step S51 that the access is enabled (decision “Y”), the CPU 11 generates the expression of a special form for the designated resource (S52). The expression of a special form is the expression that matches a predesignated condition wherein, for example, the special form is a specific byte string that is generated using random numbers and is stored in the memory 14.

That is, at step S52, a byte string is generated using random numbers, and is stored in the memory 14 in correlation with the designated resource name. Next, the CPU 11 transmits a character string, including the generated expression, to the client apparatus 2 of the user that is a predesignated transmission destination (S53). The processing is thereafter terminated. In this case, an email (transmission using a SMTP server apparatus) is employed for transmission of the character string. Since the transmission by the SMTP server apparatus is well known, no further explanation will be given.

When the CPU 11 determines at step S51 that the access should be denied (decision “N”), the processing is terminated.

When, for example, a byte string generated using random numbers relative to resource “P5” is “86d49110ad48a5dfc650445897309ac1609e8056”, character string “http://server/86d49110ad48a5dfc650445897309ac1609e8056” is transmitted to a user at a destination. Then, byte string generated using random numbers, “86d49110ad48a5dfc650445897309ac1609e8056”, is stored in the memory 14 in correlation with the resource name “P5”.

When character string “http://server/86d49110ad48a5dfc650445897309ac1609e8056” is accepted by the client apparatus 2, the CPU 11 regards the request from the client as a reference request (because a query is not added), and starts the process in FIG. 6. At step S11, the CPU 11 determines whether the character string, “86d49110ad48a5dfc650445897309ac1609e8056”, to designate the resource is stored in the memory 14. In this manner, a check is performed to determine whether expression “http://server/86d49110ad48a5dfc650445897309ac1609e8056” for the designated resource is for a special form. In this case, since the byte string “86d49110ad48a5dfc650445897309ac1609e8056” is stored in the memory 14 in correlation with the resource name “P5”, the CPU 11 determines whether this expression is for a special form, and shifts the process to step S15. Then, the CPU 11 provides the contents of the corresponding resource “P5” for the client apparatus 2 that issued a request to “http://server/86d49110ad48a5dfc650445897309ac1609e8056”. At this time, “86d49110ad48a5dfc650445897309ac1609e8056” and the corresponding resource name may be deleted from the memory 14. Through this processing, the user who received the expression in the special form can obtain access history indicating that the user accessed the resource related to the above expression.

In the above processing, the random number generation is performed; however, a hash value representing the contents of the resource may be employed instead of random numbers. In this case, the hash value representing the contents is correlated with a linking source so that the root can be reached by tracking the reference from the link source. Further, the resource name need only be included in the header information for the root, so that the resource name can be extracted from the hash value.

Another method for permitting another user to access a resource.

An example wherein request “inform” is issued to permit another user to access a resource has been explained. In some cases, when the reference for the embodiment is employed, another user can access a resource that does not belong to a network lower than the resource that the user had accessed before.

For example, assume that a user A desires a user B to access a resource corresponding to a node P6 in the network in FIG. 2. In this case, so long as the user A knows that “the user B can access a resource P2”, the user A need issue a request “edit” for the resource P2, and add a link to the resource P6.

Through this process, the user B who accessed the resource P2 before can obtain an access permission for the resource P6.

In the embodiment, in the processes for the individual request names, substantially the same process is performed to determine whether an access to a designated resource as requested should be permitted. Therefore, an access permission that permits browsing but denies editing cannot be set. Therefore, information elements relevant to types of accesses to be accepted may be stored on the magnetic disk 19. In this case, the access type related to a specific information element can be permitted by determining whether the user had accessed the specific information element.

For example, assume that resource “create.html” is stored on the magnetic disk 19 as an information element about generation (“create”), and that resource “edit.html” is stored as an information element about editing (“edit”) on the magnetic disk 19. Also assume that a user A is accessing both resource “create.html” and resource “edit.html” (for example, by using the expression of a special form). In this case, the access history for these two resources “create.html” and “edit.html” is stored in the client apparatus 2 of the user A.

Whereas, the user B is accessing only resource “edit.html” (for example, by using the expression of a special form). Then, a hash value relevant to an associative array that includes resource “edit.html” and does not include resource “create.html” is stored as the access history in the client apparatus 2 of the user B.

Therefore, in the process for request name “edit”, when the access history of the user includes a resource higher than the designated resource (the determination process is the same as at step S14 in FIG. 6), and when the access of resource “edit.html” is also included in the access history, the CPU 11 determines at step S24 in FIG. 7 that the access to the designated resource (in this case, the access for editing) can be permitted. The CPU 11 then shifts to the process beginning at step S25.

Similarly, in the process for request name “create”, when the access history of the user includes a resource higher than the designated resource (this determination process is the same as that at step S14 in FIG. 6), and when the access to “create.html” is also included in the access history, the CPU 11 determines at step S41 in FIG. 9 that the access to the designated resource (in this case, the access for editing) can be permitted. Then, the CPU 11 shifts to the process beginning at step S42.

Therefore, in the process for request name “edit”, since the access to the designated resource is included in the access history for both users A and B, the two users can edit the designated resource. However, in the process for request name “create”, since the client apparatus 2 of the user A has the access history for “create.html”, a new resource can be generated immediately above the designated resource. However, for the user B, since the access history stored in the client apparatus 2 does not include the access of “create.html”, a new resource can not be generated immediately above the designated resource, and a message that the request is not accepted is transmitted (S47).

In this manner, the access control can be performed for the contents of each request. Furthermore, when an access using request name “view” is enabled though an access for request name “edit” is denied, and when the access request using request name “edit” is received, the access for request name “view” may be permitted for a requested resource. In this case, the URI for which the request name has been changed may be written to the location field, a document with a vacant entity body may be provided, and the client apparatus 2 may be permitted to perform an access relative to request name “view”. At this time, when the preferential order is provided for the individual request names, and when the access relative to a specific request name is denied, the probability for access is examined in the preferential order. When there are request names for which the access is permitted, the access may be performed for a first request name that is found in the preferential order.

In this example, in the process for, for example, an editing request (“edit”), the process for examining an access permission may be performed in the same manner as the process for request name “view”, and in the procedure for examining the access permission in the commitment process, the access permission may be examined relative to a corresponding request name.

When an editing request, for example, is received, and when the user has a browsing (“view”) access permission, an editing form is provided, and in the commitment process performed after the form has been transmitted, the access permission for editing (“edit”) is authorized.

In a second embodiment, an explanation will now be given for a web server apparatus, that can set, for each request name, an access permission for each resource. The web server apparatus in the embodiment has substantially the same configuration as the web server apparatus for the first embodiment, except that the contents of the processing performed by the CPU 11 differ, and an additional table is stored on the magnetic disk 19. This difference of the configuration between the first and the second embodiments will now be described.

In the second embodiment, as is shown in FIG. 11, a table is stored wherein resources are defined to limit access permissions related to the individual request names. In this table, request name “qualify” for changing an access permission condition is additionally stored. The process performed for this request name will be described later.

The CPU 11 basically performs the processes shown in FIGS. 6, 7, 9 and 10 relative to request names “view”, “edit”, “create” and “inform”. However, the process at step S24 in FIG. 7, the process at step S41 in FIG. 9 and the process at step S51 in FIG. 10 are different.

Specifically, when, for example, the CPU 11 receives a request of request name “edit” for the resource P1, the CPU 11 begins the process for request name “edit”. At step S24 in FIG. 7, the CPU 11 obtains resource name “Px” that is defined in the table in FIG. 11 in correlation with the resource P1 and request name “edit”. When a resource higher than the designated resource is present on the list of node names included in the access history for a user (this determination process is the same as at step S14 in FIG. 6), and when the access for the obtained resource name “Px” is permitted (this determination process is the same as at step S14 when the resource name “Px” is for a designated resource, i.e., when the node name for a resource higher than the designated resource is included in the access history), the CPU 11 determines that the access to the designated resource (the access for editing) should be permitted. Then, the CPU 11 shifts to the process beginning at step S25. Similarly, for the request names “create” and “inform”, the table in FIG. 11 is examined to determine the permission of the access. When the resource correlated with both the designated resource and the request name matches a condition wherein “the resource was accessed by the user before, or is located lower than another resource accessed by the user in the past”, and a condition wherein “the user had accessed the designated resource, or the designated resource is located lower than a specific resource accessed by the user in the past”, the CPU 11 determines that the access for the designated resource should be permitted relative to the designated request name.

Process Performed to Generate a New Resource Based on “Edit” and “Create”

When a new resource (resource immediately below) linked from the designated resource, or a new resource (resource immediately above) liked to the designated resource is generated in response to request name “edit” or “create”, an entry for the new resource is additionally provided in the table in FIG. 11.

When a resource immediately below the designated resource is generated for a resource designated by request name “edit”, the additional entry has the same setup as the designated resource. For example, when a resource immediately below is generated for the resource P1 in FIG. 11, “Px” for “edit”, “Py” for “create”, “Pz” for “inform” and “Pw” for “qualify” are set in the entry for the generated resource.

When a resource immediately above the designated resource is generated for a resource designated by request name “create”, the additional entry has the same setup as the designated resource as for request names except for “qualify”. For example, when resource “Pq” immediately above is generated for the resource P1 in FIG. 11, “Px” for “edit”, “Py” for “create”, “Pz” for “inform” and “Pq” that is the generated resource itself for “qualify” are set in the entry for the generated resource.

Process Performed for Request Name “Qualify”

A request for editing the list for access control shown in FIG. 11 is defined as “qualify”.

The process for request name “qualify” will now be described. First, the CPU 11 determines whether a user can access a designated resource for request name “qualify”. Specifically, when an entry for resource P1 is changed in FIG. 11, the resource name “Pw” correlated with the resource P1 and request name “qualify” is obtained. When the requesting user had accessed the resource of the obtained resource name “Pw” itself, or a resource higher than the “Pw”, the values correlated with the individual request names relative to the resource P1 can be changed. In this example, the resource name is correlated with the request name; however, instead of the resource name, the hash value operated based on the resource name may be correlated with the request name.

The present invention is not limited to the first and the second embodiments. In these embodiments, the database that provides the individual tables and the information element network have been formed on the magnetic disk 19. However, for example, the database and the information element network may be formed on the disk drive of another server apparatus that can communicate with the web server apparatus 100 through the network 3.

Furthermore, in the embodiments, the information element network is formed in the acyclic digraph shape; however, the information element network is not limited to this shape, and may be a cyclic digraph.

In addition, so long as the processes explained for the first and second embodiments can be performed, the present invention can be applied also for a file system in addition to the above described web server apparatus.

According to a first configuration, there is provided a server apparatus connected to a client apparatus and a database that stores an information element network including information elements as nodes, the server apparatus including: a receiving unit that receives from the client apparatus a request to access a specific information element included in the information element network; an obtaining unit that obtains from the client apparatus information concerning an access history for the information elements; and a determining unit that determines whether the client apparatus previously accessed an information element included in the information element network and is included in upper nodes with respect to the specific information element, and employs the determined result to ascertain whether to permit or deny access to the specific information element requested by the client apparatus.

An information element related to a type of an access to be accepted may be included in the information element network stored in the database, and the determining unit may configured to determine, according to the information element, whether to permit or deny an access type relevant to the specific information element depending on whether the client apparatus has previously accessed the information element.

According to a second configuration, there is provided a server apparatus connected to a client apparatus and a database that stores an information element network including information elements as nodes, the server apparatus including: an access key storage unit that stores at least part of the information elements in correlation with at least one information element that is used as an access key for each of types of access to the information elements; a receiving unit that receives from the client apparatus a request to access a specific information element included in the information element network; an obtaining unit that obtains from the client apparatus information concerning an access history for the information elements; and a determining unit that employs the obtained information to determine whether the client apparatus previously accessed one of the information elements that is correlated, as an access key, with the type of access for the specific information element, and employs the determined result to determine whether to permit or deny access to the specific information element requested by the client apparatus.

Since whether to permit or deny access to the resource is determined in accordance with the access history of the client apparatus, access control can be performed without management data being required for each user, such as a prior registration of the user.

In the above configurations, the server apparatus may further include: a characteristic parameter calculating unit that calculates a characteristic parameter related to an information element; and a transmitting unit that transmits relevant information extracted from the specific information element to the client apparatus when the client apparatus is permitted to access the specific information element, wherein the relevant information transmitted and stored in the client apparatus may be employed, as information relevant to he access history.

With this arrangement, whether to permit or inhibit access to the resource can be determined based on the access history of the client apparatus, and access control can be performed without management data being required for each user, such as a prior registration of the user.

The characteristic parameter calculating unit may calculate a different characteristic parameter concerning a list of nodes that are previously accessed, and the different characteristic parameter may be employed as information concerning the relevant information. With this arrangement, the relevant information can be expressed using a shorter data string.

The characteristic parameter calculating unit may calculate the characteristic parameter using a method that, in a space occupied by all parameters available as the characteristic parameter, a probability equal to or smaller than a predetermined value is set for the distribution of one of the available parameters that corresponds to one of the information elements. With this arrangement, robustness is increased relative to an attack mounted to obtain an access permission by an analogical inference based on a characteristic parameter.

According to a third configuration, there is provided a server apparatus including: a managing unit that manages a database having a structure including one or more resources; a determining unit that determines a permission to access a resource included in the database, based on a resource name that is received when a request to access the resource is submitted, and use context information that describes an access history for the database. With this arrangement, a complicated preparation, such as an account registration, is not required.

The determining unit may determine the permission by ascertaining whether the resource name is included in the use context information. As a result, the determination process is simplified.

The database may have a structure that one or more resources are correlated with one another, the structure including at least one of a network structure having the resources as nodes or a tree structure having the resources as nodes. This structure can then be applied for a wide range of databases.

The database may have a structure that includes a plurality of nodes, and inter-node reference information is provided for each of the nodes, and the user context information may include a previously accessed reference source node that corresponds to the resource name of the node that is defined uppermost. When access to the reference destination is to be permitted so long as the resource for the highest node is at the least obtained, the permission to access the resource can be easily determined.

The server apparatus serves as a web server that receives the resource name as a URL and the user context information as information for a cookie area. Since a general message style employed for a web server apparatus that uses a markup language such as HTML can be employed, and a special form need not be used, the present invention can be easily applied for a web server apparatus.

The user context information may include a hash value calculated based on the resource name. Since the user context information corresponds to the resource name, the determination process can be easily performed.

The user context information may include a hash value calculated based on the resource name and the content of the resource. Since the contents of the resource is also included in the user context information, analogical inference of the characteristic parameter is difficult, compared with an inference arrived at using the resource name. Thus, a user who only accesses the resource for browsing is permitted, and safe access control can be performed.

The server apparatus may further include a communication unit that receives the resource name in a special form for a first access to the database, transmits the resource name and the user context information in a normal form, and receives an access request including the resource name and the user context information in the normal form. With this arrangement, when a resource name using a special form is received from an owner having an access permission, the first access can be introduced. Further, since the normal resource name and the normal context information is returned in response to the resource indicated by the resource name using the special form, the same determination process can be performed for a second or a subsequent access permission request. Thus, the determination process can be simplified.

Since the substance of a response is not directly returned upon the reception of a request designating a resource name using a special form, the resource name of the special form is prevented from being exposed, and security is increased.

The database may include resource names and hash values based on the contents of resources corresponding to the resource names, and the resource name in the special form may include a hash value based on the contents of a resource corresponding to the resource name. Since the database includes the resource names and the hash values based on the contents of resources corresponding to the resource names, a resource name having a special form is not paired with a normal resource name, can be converted into a normal resource name, and can be transmitted as the normal resource name to the client apparatus (even when the resource contents are changed, the original resource name can be used because a linked list is provided that includes a link to the previous version.

According to a fourth configuration, there is provided an information providing method for a server apparatus that is connected to a client apparatus and a database that stores an information element network including information elements as nodes, the method including: receiving, from the client apparatus, a request to access a specific information element included in the information element network; obtaining, from the client apparatus, information concerning an access history for the information elements included in the information element network; determining whether the client apparatus previously accessed an information element included in the information element network and is included in upper nodes with respect to the specific information element; and employing the determined result to ascertain whether to permit or deny access to the specific information element requested by the client apparatus.

According to a fifth configuration, there is provided an information providing program product for causing a server apparatus that is connected to a client apparatus and a database that stores an information element network including information elements as nodes, to execute procedures including: receiving, from the client apparatus, a request to access a specific information element included in the information element network; obtaining, from the client apparatus, information concerning an access history for the information elements included in the information element network; determining whether the client apparatus previously accessed an information element included in the information element network and is included in upper nodes with respect to the specific information element; and employing the determined result to ascertain whether to permit or deny access to the specific information element requested by the client apparatus.

According to the configurations described above, since the permission or denial of the access to a resource is determined based on the access history of the client apparatus, the access control can be performed without requiring a user pre-registration and management of information for each user, and the usability can be improved.

Although the present invention has been shown and described with reference to a specific embodiment, various changes and modifications will be apparent to those skilled in the art from the teachings herein. Such changes and modifications as are obvious are deemed to come within the spirit, scope and contemplation of the invention as defined in the appended claims.

The entire disclosure of Japanese Patent Application No. 2003-357084 filed on Oct. 16, 2003 including specification, claims, drawings and abstract is incorporated herein by reference in its entirety.

1. A server apparatus connected to a client apparatus and a database that stores an information element network including an information element as node, the server apparatus comprising:
a receiving unit that receives from the client apparatus a request to access a specific information element included in the information element network;
an obtaining unit that obtains from the client apparatus information concerning an access history for the information element; and
a determining unit that determines whether the client apparatus previously accessed an information element included in the information element network and included in upper node with respect to the specific information element based on the information obtained by the obtaining unit, and employs the determined result to ascertain whether to permit or deny access to the specific information element requested by the client apparatus.

2. The server apparatus according to claim 1, wherein an information element related to a type of an access to be accepted is included in the information element network stored in the database, and
wherein the determining unit determines, according to the information element, whether to permit or deny an access type relevant to the specific information element depending on whether the client apparatus has previously accessed the information element.

3. The server apparatus according to claim 1, further comprising:
a characteristic parameter calculating unit that calculates a characteristic parameter related to an information element; and
a transmitting unit that transmits relevant information extracted from the specific information element to the client apparatus when the client apparatus is permitted to access the specific information element,
wherein the relevant information transmitted and stored in the client apparatus is employed, as information relevant to the access history.

4. The server apparatus according to claim 3, wherein the characteristic parameter calculating unit calculates a different characteristic parameter concerning a list of nodes that are previously accessed, and
wherein the different characteristic parameter is employed as information concerning the relevant information.

5. The server apparatus according to claim 3, wherein the characteristic parameter calculating unit calculates the characteristic parameter using a method that, in a space occupied by all parameters available as the characteristic parameter, a probability equal to or smaller than a predetermined value is set for distribution of one of the available parameters that corresponds to one of the information elements.

6. A server apparatus connected to a client apparatus and a database that stores an information element network including an information element as node, the server apparatus comprising:
an access key storage unit that stores at least part of the information element in correlation with at least one information element that is used as an access key for each of types of access to the information elements;
a receiving unit that receives from the client apparatus a request to access a specific information element included in the information element network;
an obtaining unit that obtains from the client apparatus information concerning an access history for the information elements; and
a determining unit that employs the obtained information to determine whether the client apparatus previously accessed one of the information elements that is correlated, as an access key, with the type of access for the specific information element, and employs the determined result to determine whether to permit or deny access to the specific information element requested by the client apparatus.

7. The server apparatus according to claim 6, further comprising:
a characteristic parameter calculating unit that calculates a characteristic parameter related to an information element; and
a transmitting unit that transmits relevant information extracted from the specific information element to the client apparatus when the client apparatus is permitted to access the specific information element,
wherein the relevant information transmitted and stored in the client apparatus is employed, as information relevant to the access history.

8. The server apparatus according to claim 7, wherein the characteristic parameter calculating unit calculates a different characteristic parameter concerning a list of nodes that are previously accessed, and
wherein the different characteristic parameter is employed as information concerning the relevant information.

9. The server apparatus according to claim 7, wherein the characteristic parameter calculating unit calculates the characteristic parameter using a method that, in a space occupied by all parameters available as the characteristic parameter, a probability equal to or smaller than a predetermined value is set for distribution of one of the available parameters that corresponds to one of the information elements.

10. A server apparatus comprising:
a managing unit that manages a database having a structure including one or more resources;
a determining unit that determines a permission to access a resource included in the database, based on a resource name that is received when a request to access the resource is submitted, and use context information that describes an access history for the database.

11. The server apparatus according to claim 10, wherein the determining unit determines the permission by ascertaining whether the resource name is included in the use context information.

12. The server apparatus according to claim 10, wherein the database has a structure that one or more resources are correlated with one another, the structure including at least one of a network structure having the resource as node and a tree structure having the resource as node.

13. The server apparatus according to claim 10, wherein the database has a structure that includes a plurality of nodes, and inter-node reference information is provided for each of the nodes, and
wherein the user context information includes a previously accessed reference source node that corresponds to the resource name of the node that is defined uppermost.

14. The server apparatus according to claim 10, wherein the server apparatus is a web server that receives the resource name as a URL and the user context information as information for a cookie area.

15. The server apparatus according to claim 10, wherein the user context information includes a hash value calculated based on the resource name.

16. The server apparatus according to claim 10, wherein the user context information includes a hash value calculated based on the resource name and the content of the resource.

17. The server apparatus according to claim 10, further comprising a communication unit that receives the resource name in a special form for a first access to the database, transmits the resource name and the user context information in a normal form, and receives an access request including the resource name and the user context information in the normal form.

18. The server apparatus according to claim 17, wherein the database includes resource names and hash values based on the contents of resources corresponding to the resource names, and
wherein the resource name in the special form includes a hash value based on the contents of a resource corresponding to the resource name.

19. An information providing method for a server apparatus that is connected to a client apparatus and a database that stores an information element network including a information element as node, the method comprising:
receiving, from the client apparatus, a request to access a specific information element included in the information element network;
obtaining, from the client apparatus, information concerning an access history for the information element included in the information element network;
determining whether the client apparatus previously accessed an information element included in the information element network and included in upper nodes with respect to the specific information element; and
employing the determined result to ascertain whether to permit or deny access to the specific information element requested by the client apparatus.

20. An information providing program product for causing a server apparatus that is connected to a client apparatus and a database that stores an information element network including an information element as node, to execute procedures comprising:
receiving, from the client apparatus, a request to access a specific information element included in the information element network;
obtaining, from the client apparatus, information concerning an access history for the information element included in the information element network;
determining whether the client apparatus previously accessed an information element included in the information element network and included in upper nodes with respect to the specific information element; and
employing the determined result to ascertain whether to permit or deny access to the specific information element requested by the client apparatus.
